(19) United States
(12) Patent Application Publication
(10) Pub. No.: US 2005/0106050 A1
(43) Pub. Date: May 19, 2005

(54) Hand pump with pressure release mechanism and system of use

(76) Inventors: Christian Hunt, McLean, VA (US); John A. Spadavecchia, Red House, VA (US)

Correspondence Address: MCGUIREWOODS, LLP, 1750 TYSONS BLVD, SUITE 1800, MCLEAN, VA, 22102, US

(21) Appl. No.: 10/961,213

(22) Filed: Oct. 12, 2004

Related U.S. Application Data
(60) Provisional application No. 60/519,793, filed on Nov. 14, 2003.

(51) Int. Cl. G01F 11/06; G01F 11/30

(52) U.S. Cl. 417/440; 417/552

(57) ABSTRACT

A hand pump includes a pumping system having a primary pressure chamber and a valve control assembly. The valve assembly includes a vent passageway in communication between the primary pressure chamber and ambient and a valve seal assembly having a seal and a seat. A biasing mechanism biases the seal against the seat to obstruct fluid or gas passage in the vent passageway to ambient. A traction device may be fluidly coupled to the hand pump system.

### CROSS REFERENCE TO RELATED APPLICATIONS

This application claims priority to provisional application Ser. No. 60/519,793, filed on Nov. 14, 2003, and which is now incorporated in its entirety by reference.

### BACKGROUND OF THE INVENTION

1. Field of the Invention

The invention generally relates to a hand pump and, more particularly, to a hand pump having a pressure release mechanism and automatic return to a shut-off position and system of use.

2. Background Description

Pumps come in a variety of different configurations designed for a variety of different applications. For example, some pumps are specifically designed for fluid applications such as centrifugal pumps. Still other pumps are designed for air or compressible fluids. In any case, a pump is designed to lift, transfer, or increase the pressure of a fluid (gas or liquid) or to create a vacuum in an enclosed space by the removal of a gas.

The centrifugal pump is a very common type of pump and includes a rotating device, called an impeller, inside a casing. The fluid to be pumped enters the casing near the shaft of the impeller and vanes are used to move the fluid, at a high velocity, through an outlet. These types of pumps typically do not have or require a means to release the pressure within the system.

A reciprocating pump moves a fluid or gas using a piston and cylinder assembly. In these common types of pumps, the piston moves within the cylinder to provide the pumping action. More specifically, the piston will typically include an o-ring which provides a seal between the piston head and the inner wall of the cylinder. As the piston is moved in a forward direction, it will force air through a hose and into a system in a pressurized state. This system can be, for example, an inner tube. By using this type of system, the air can be forced into the inner tube in order to pressurize or inflate the inner tube.

In other applications, it is known to use a hand pump to pressurize and de-pressurize a pneumatic cylinder on a traction device. One such device is disclosed in U.S. Pat. No. 6,059,548 to Campbell et al, and assigned to The Saunders Group, Inc. In this assembly, a conventional piston and cylinder hand pump is used with a complex flow control assembly. This assembly includes a vent to release air from the system.

By way of discussion, the system disclosed in U.S. Pat. No. 6,059,548 includes a pump head 56 for receiving a stem portion 60 of a flow control assembly 62. A tab 67 is located on the housing 64 and engages with slot a 69 on the pump head 56, which is designed to limit a rotational movement of the flow control assembly 62. A housing end cap 70 is provided for sealing a pressure gauge 68 into the gauge housing 64. A vent seal 96 is located on the stem portion 60 proximate a vent 98 on the pump head 56. To release air from the system, the gauge housing 64 must be rotated such that the vent seal 96 is rotated past the vent 98, exposing it to pressurized air in the stem chamber 104. Pressurized air in the primary chamber 74 can now move through the stem passageway 92 into the stem chamber 104, and through the vent 98. In the positive shut-off position, the vent hole is sealed with the vent seal and the stem passageway is sealed with a pump seal.

As can be seen, the system disclosed in U.S. Pat. No. 6,059,548 includes a complex array of components, which increases manufacturing costs and assembly time. By example, there are two seals that are provided in order to effectuate a shut-off. Also, this system does not appear to be very intuitive to use since it requires a rotational movement of an entire assembly. In fact, in such a system, a user may try to pressurize the system when the gauge housing is rotated in the released position (shown as reference numeral 124). This may become frustrating to the user. Also, there does not appear to be any mechanism which would address this problem such as, for example, a mechanism which automatically returns the system to the shut-off position (shown by reference numeral 122). Likewise, the user may attempt to depressurize the system when a traction force is applied only to realize that they are rotating the housing in a wrong direction.

### SUMMARY OF THE INVENTION

In a first aspect of the invention, a hand pump includes a pumping system having a primary pressure chamber and a valve control assembly. The valve control assembly includes a vent passageway in communication between the primary pressure chamber and ambient and a valve seal assembly having a seal and a seat. A biasing mechanism biases the seal against the seat to obstruct fluid or gas passage in the vent passageway to ambient.

In another aspect of the invention, a traction device is fluidly coupled to the hand pump system.

In still another aspect of the invention, a hand pump system is provided for pressurizing and de-pressurizing a pneumatic cylinder. The hand pump system comprises a hand pump having primary chamber with a vent hole and a housing assembly coupled to the hand pump. The housing assembly houses an air line and a venting control assembly. The venting control assembly includes a valve housing having a first chamber and a second chamber, and an inner wall partitioning the first chamber and the second chamber. The wall includes a bore providing communication between the first chamber and the second chamber. A biasing mechanism is provided for biasing a seal on the inner wall to provide a venting obstruction.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a side view of a portable traction device;

FIG. 2 shows a pump in accordance with the invention;

FIG. 3 shows an exploded cross sectional view of the valve mechanism of the pump in a shut-off position in accordance with the invention; and

FIG. 4 shows an exploded cross sectional view of the valve mechanism of the pump in a release position in accordance with the invention.

### DETAILED DESCRIPTION OF EMBODIMENTS OF THE INVENTION

The invention is directed to a hand pump and, more particularly, to a hand pump having a pressure release mechanism and automatic return to a shut-off position. The invention is also directed to a system using the hand pump. This system may be a traction device such as, for example, a cervical or lumbar traction device.

The hand pump of the invention is designed to provide a pressure release mechanism and an automatic return to a shut-off position. By using the pump of the invention, the user can pressurize a system without regard to the position of the release mechanism since it will automatically return to the shut-off position. In this manner, a system will always be in a charge ready state. Also, the pressure release mechanism of the invention includes a depressible button-type mechanism which is easy and intuitive to use. For example, to depressurize the system, a user need only depress a button.

### System of the Invention

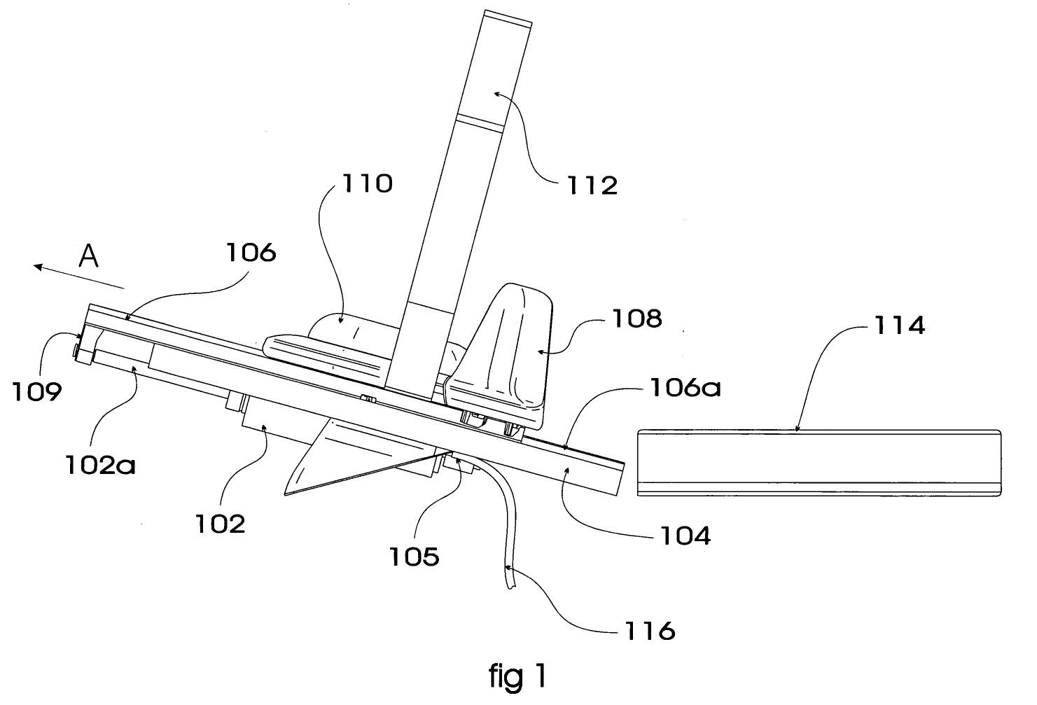

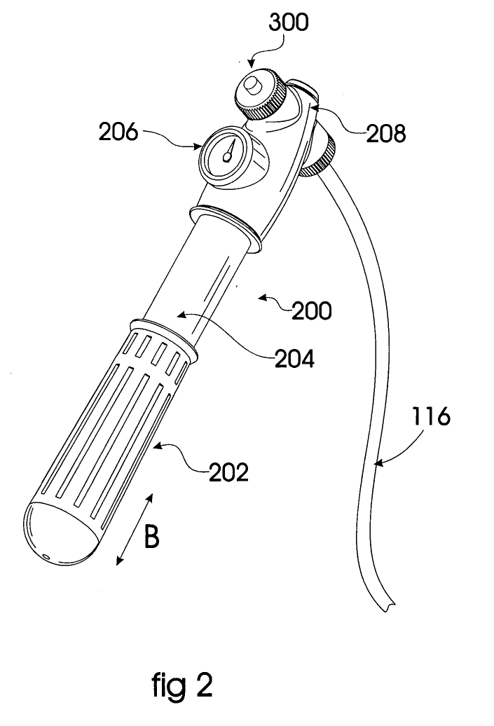

Referring now to FIG. 1, a side view of an exemplary portable traction device is shown, generally depicted as reference numeral 100. In this embodiment, the traction device is a cervical traction device, but it should be understood that a lumbar traction device or other system requiring pressurization may be used with the hand pump of the invention, as shown and described with reference to FIGS. 2-4.

The cervical traction device 100 includes a pneumatic cylinder assembly 102 mounted between a support structure 104 and a movable carriage 106. The movable carriage 106 is allowed to move freely along a track 106a in a direction “A” via the pressurization of the pneumatic cylinder assembly 102. The piston rod is mounted to a bracket 109 on the moveable carriage 106.

In one embodiment, the pneumatic cylinder 102 is a single-acting pneumatic cylinder with the rod 102a connected to the bracket 109. The rod 102a includes a piston head that has a diameter slightly smaller than the inside diameter of the cylinder housing 102. A slot extending around the outside circumference of the piston contains a compression seal. In this design, the compression seal is an o-ring seal that remains in contact or engaged with the inner wall of the cylinder housing, regardless of the application of pressure within the cylinder housing. The o-ring provides a uniform and constant frictional force on the cylinder wall.

An air inlet 105 is provided at an end of the cylinder housing 102 to provide pressurized air to the cylinder assembly via the hand pump. An air line 116 is attached between the air inlet 105 and the hand pump. Of course, it should be understood, though, that the use of the hand pump is not limited to this specific type of pneumatic cylinder described above and that any cylinder assembly can be utilized with the hand pump.

As shown further in FIG. 1, the traction device includes an occipital wedge system 108 for applying a therapeutic traction force to the occipital areas on a patent's head and neck. The occipital wedges 108 are mounted to the movable carriage 106, and may have a concave engaging surface. The occipital wedges 108 may move or slide on the carriage. A head pad 110 and accompanying restraining belt or strap 112 is also mounted on the moveable carriage 106. A back support pad 114 may be provided proximate the moveable carriage 106. A stand 116 may be mounted to the support structure 104 in order to adjust an angle of the moveable carriage 106 with respect to the back support pad 114.

FIG. 2 shows the hand pump in accordance with the invention. The hand pump is depicted generally as reference numeral 200 and includes a pump handle 202 slidably mounted to a pump housing 208. The pump handle 202 can move in direction of arrow “B” in order to provide pressure to a system. The pump 200 includes a conventional piston and seal assembly well known in the industry to provide pressurized air through the air line or hose 116. The hand pump 200 additionally includes a pressure or force gauge 206, any type well known to those of skill in the art. A pressure release mechanism 300 is also provided on the hand pump, and may be included within a housing assembly 208 with the pressure gauge 206 and the inlet 210 to the air hose 116.

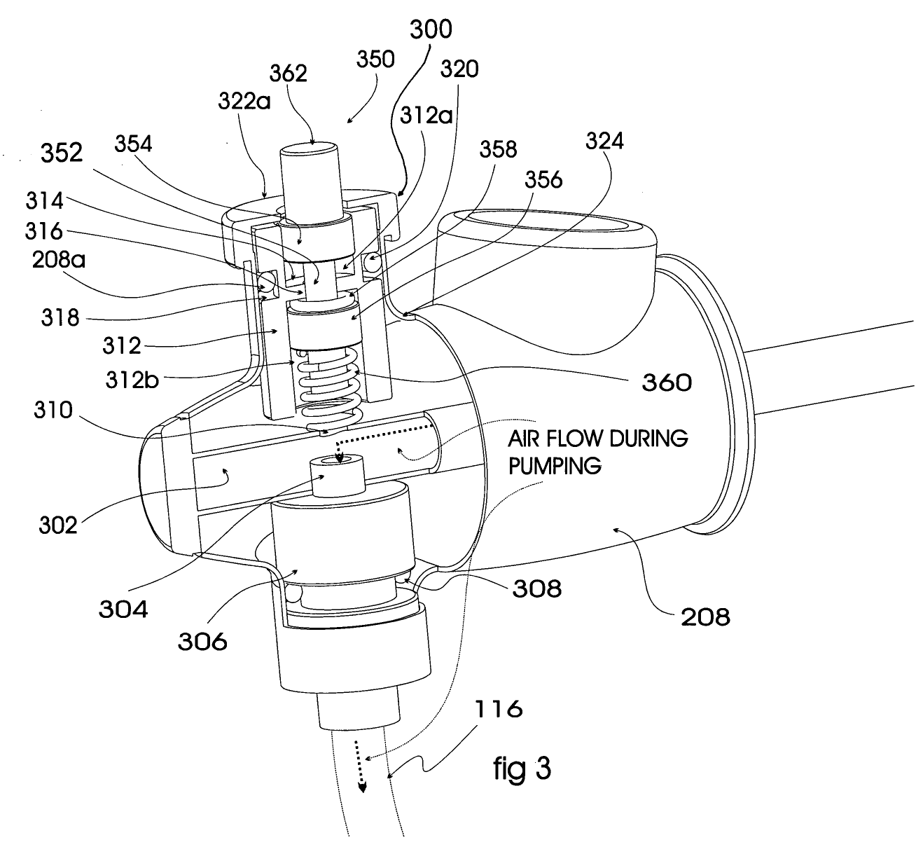

FIG. 3 shows a cutaway view of the hand pump of the invention. The exploded view shows a primary chamber 302 in fluid coupling to an air inlet 304 and hence the air line or hose 116. The air inlet 304 is provided within a housing 306 mounted to the assembly 208. A seal 308 such as an o-ring is provided between the housing 306 and the assembly 208 to ensure an air tight seal between the housing 306 and the assembly 208.

A hole or bore 310 is provided in the primary chamber 302 in substantial alignment with the pressure release mechanism 300. The pressure release mechanism 300 includes a substantially cylindrical valve housing 312 having an inner extending partition wall 314 with a substantially centrally located bore 316. The valve housing 312 may equally have other cross sectional areas such as, for example, rectilinear or oval, to name a few. The bore 316 allows fluid communication (e.g., fluid, air or other gas) between a first chamber 312a and a second chamber 312b of the valve housing 312.

The valve housing 312 further includes a groove 318 provided about the outer wall or circumference. A seal 320 is seated within the groove 318 and provides a seal between the valve housing 312 and an inner wall 208a of the assembly 306. This is substantially a static communication. An end cap 322 is provided over the valve housing 312 and is coupled to the assembly 208 to ensure that the valve housing 312 remains substantially stationary within the assembly 208.

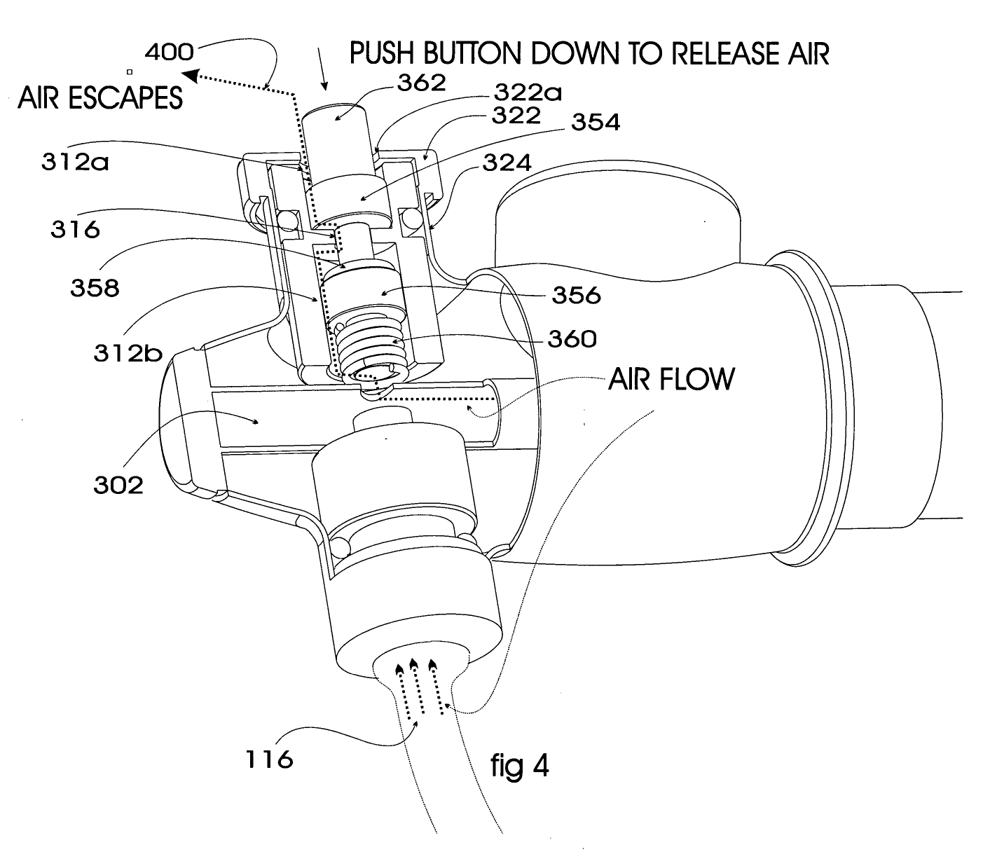

The pressure relief mechanism 300 further includes a valve assembly generally depicted as reference numeral 350. The valve assembly 350 includes a stem or push rod 352 extending between the chambers 312a and 312b. In this configuration, the stem 352 also extends through the bore 316 provided within the inner extending partition wall 314. The bore 316 is slightly larger than the stem 352 to allow release of air or other fluids or gas during the pressure release stage of operation, shown in FIG. 4.

Flanges 354 and 356 are provided in respective chambers 312a and 312b, on opposing sides of the bore 316 provided within the inner extending partition wall 314. The flanges 354 and 356 are outward projections extending or formed about the circumference of the stem 352, forming a stepped or larger cross sectional area than that of the stem 352. In one embodiment, the flange 354 is limited in movement between the inner extending partition wall 314 and the end cap 322. The flanges 354 and 356 also limit travel of the valve assembly by (i) the flange 354 contacting the end cap 322 and/or (ii) the flange 356 contacting the inner extending partition wall 314.

A seal 358 is provided between the flange 356 and the bore 316 within the inner extending partition wall 314. In one implementation, the seal 358 may be bonded to a surface of the flange 356. In this configuration, the seal 358 will move with and in conjunction with the entire valve assembly.

A biasing spring 360 is provided substantially with the chamber 312b and in mechanical communication with a wall of the primary chamber 310 and the flange 356. The biasing spring 360 biases the valve assembly 350 upwards towards the end cap 322. As a result of this biasing, the seal 358 is tightly held between the inner extending partition wall 314, about the bore 316, and the flange 356 to provide a shut-off or obstruction between the primary chamber 310 and ambient. That is, the seal 358 will ensure no pressure release or leakage through the valve assembly 358 from the primary chamber by obstructing a pressure release passage.

A push button 362 extends outwardly from a hole 322a in the end cap 322. The push button 362 is mechanically coupled to the stem 352. The hole 322a is larger than the cross sectional area of the push 362 to provide a portion of the pressure release passage, as described in more detail below.

It should be understood that an increase in pressure of the system will also increase the sealing capabilities of the seal against the bore 316. In particular, air pressure will act on a surface of the flange 354 which, in turn, will force the flange 354 upwards against the seal 358 and bore. As the pressure increases, the force applied on the flange will also increase thus providing a greater force on the seal 358. The greater force acting on the seal will then provide a greater sealing force against the bore preventing any leakage of air, fluid or other gases to ambient. This will thus enable the system to maintain a constant static pressure over a period of time, with minimal to no leakage. The hand pump is designed to withstand pressures and leakage of at least 175 kPa (25 psi), for example.

FIG. 4 shows an exploded cross sectional view of the valve mechanism of the pump in a released or open position in accordance with the invention. In this operational stage, the push button 362 is depressed in order to provide a fluid release passage 400. In particular, the depression of the push button 362 forces the stem 352 and accompanying flanges 354 and 356 downward toward the primary chamber 302. As the flange 356 moves away from the inner extending partition wall 314, the seal 358 will unseat from the wall 314 and more particularly about the bore 316. In this operational stage, the spring 360 will also become compressed. After the seal is unseated, a pressure release passage will be provided, including:
(1) from the primary chamber (and/or also the air line);
(2) into and through the chamber 312b;
(3) through the bore 316 and flowing about the stem between the flanges;
(4) into and through the chamber 312a; and
(5) through the hole 322a to ambient.

Upon release of the push button, the spring 360 will automatically bias the valve assembly to the shut-off position. That is, the spring 360 will bias the seal 358 into sealing contact with the bore 316 blocking or obstructing the pressure release passage 400. During this operational stage, air, fluid or other gases can then enter into the system, e.g., traction device, for pressurization. This operational stage is shown in FIG. 3.

### Operation of Use

To use the traction device, the cylinder assembly is initially at atmospheric pressure. The back of the user is placed on a support surface so that the neck is cradled by the wedges. The user then pumps air into the cylinder using the pump. At this time, the push button and valve assembly is biased upwards by the spring to the shut-off position. During this operational stage, air, fluid or other gases can then enter into the system for pressurization.

The user increases the traction force by manually operating the pump. As air is pumped into the cylinder, the piston will extend from the cylinder housing and the carriage will begin to separate from the support structure. In this manner, a traction force will be provided to the user. At the end of a session or during the session, the user can decrease the traction force by manually pressing the pressure relief mechanism to thus open the pressure release passage 400 to ambient. This action permits a controlled release of the pressurized air, fluid or other gas. Upon release of the button, the system will automatically revert to the ready to charge state.

While the invention has been described in terms of embodiments, those skilled in the art will recognize that the invention can be practiced with modification within the spirit and scope of the appended claims.

1. A hand pump for pressurizing and de-pressurizing a system, comprising:
a pumping system having a primary pressure chamber;
a valve control assembly, including:
a vent passageway providing communication between the primary pressure chamber and ambient;
a valve seal assembly having a seal and a seat; and
a biasing mechanism biasing the seal against the seat to obstruct fluid or gas passage in the vent passageway to ambient.

2. The hand pump of claim 1, wherein the valve seal assembly, comprises:
a housing having a first compartment and a second compartment;
an inner wall partitioning the first compartment from the second compartment, the inner wall having a bore therein; and
a stem member extending between the first compartment and the second compartment and within the bore,
wherein the seat is provided on the inner wall about the bore and the seal is biased against the inner wall by the biasing mechanism.

3. The hand pump of claim 2, wherein the biasing mechanism is a spring.

4. The hand pump of claim 2, wherein:
the housing includes a static seal seating thereabout to prevent leakage about the housing from the primary chamber,
the primary chamber has a venting hole, and
the housing is in fluid communication with the venting hole.

5. The hand pump of claim 2, further comprising a depressible mechanism in mechanical communication with the stem, the depressible mechanism, in a depressed position, provides an opening in the vent passageway to allow venting to ambient.

6. The hand pump of claim 5, wherein the depressible mechanism in a non-depressed position results in an obstruction in the vent passageway to prevent venting to ambient by the seal being biased against the inner wall about the bore therein.

7. The hand pump of claim 6, wherein the biasing mechanism places the depressible mechanism in the non-depressed position.

8. The hand pump of claim 6, wherein the non-depressed position of the depressible mechanism is provided automatically by the biasing mechanism.

9. The hand pump of claim 2, further comprising:
a first flange portion extending about a first portion of the stem in the first compartment; and
a second flange portion extending about a second portion of the stem in the second compartment,
wherein the biasing mechanism is in mechanical communication with the second flange to bias the seal against the inner wall providing an obstruction in the vent passageway.

10. The hand pump of claim 9, wherein the seal is formed integrally with a surface of the second flange.

11. The hand pump of claim 2, further comprising a seal between the housing and a housing assembly.

12. The hand pump of claim 2, further comprising a cap having a bore therein, the cap holding the housing within an assembly of the pumping system.

13. The hand pump of claim 1, wherein the valve seal assembly further comprises:
a first compartment;
a second compartment;
an inner wall partitioning the first compartment from the second compartment, the inner wall having a bore therein; and
an end cap having a bore therein, wherein
the seat is provided on the inner wall about the bore and the seal is biased against the inner wall by the biasing mechanism,
the venting passageway is provided from the primary pressure chamber through the first chamber, the bore of the inner wall, the second chamber, and the bore of the end cap.

14. The hand pump of claim 13, wherein the seal provides an obstruction at the bore of the inner wall in a shut-off position to prevent venting to ambient.

15. The hand pump of claim 1, wherein the valve control assembly includes two positions comprising a seal release position and an obstruction position.

16. The hand pump of claim 15, wherein the valve control assembly is provided in the obstruction position by a biasing of the biasing mechanism.

17. The hand pump system of claim 1 wherein pressure from the primary pressure chamber assists the seal of the valve control assembly to prevent venting to ambient.

18. A traction device fluidly coupled to the hand pump system of claim 1.

19. A hand pump system for pressurizing and de-pressurizing a pneumatic cylinder, the hand pump system comprising:
a hand pump having primary chamber with a vent hole;
a housing assembly coupled to the hand pump, wherein the housing assembly houses:
an air line adapted to provide pressure to the pneumatic cylinder; and
a venting control assembly, including:
a valve housing having a first chamber and a second chamber;
an inner wall partitioning the first chamber and the second chamber and including a bore providing communication between the first chamber and the second chamber;
a stem extending within the first chamber and the second chamber and through the bore;
a biasing mechanism; and
a seal positioned about the stem in the second chamber and seating on the inner wall to provide a venting obstruction when the biasing mechanism biases the stem away from the primary chamber.

20. The hand pump system of claim 19, further comprising a cap having a bore therein, the stem extending through the bore of the cap and acting as a depressible mechanism.

21. The hand pump system of claim 20, wherein a venting passageway includes passing through the first chamber, the bore of the inner wall, the second chamber and the bore of the cap.

22. The hand pump system of claim 19, wherein the valve assembly includes a first position and a second position, in the second position, the seal is seated on the inner wall to provide the venting obstruction when the biasing mechanism biases the stem away from the primary chamber and returns automatically to the first position upon release of the depressible mechanism.
